(19) United States
(12) Patent Application Publication
(10) Pub. No.: US 2011/0317758 A1
(43) Pub. Date: Dec. 29, 2011

(54) IMAGE PROCESSING APPARATUS AND METHOD OF PROCESSING IMAGE AND VIDEO

(76) Inventor: Kiyoto SOMEYA, Tokyo (JP)

(21) Appl. No.: 13/165,944

(22) Filed: Jun. 22, 2011

(30) Foreign Application Priority Data
Jun. 29, 2010 (JP) P2010-147633

(51) Int. Cl. H04N 7/26

(52) U.S. Cl. 375/240.03; 375/240.02; 375/E07.126; 375/E07.139

(57) ABSTRACT

An image processing apparatus including: an encoding section encoding image data including images from a plurality of viewpoints; an amount-of-code calculation section determining a viewpoint and a picture type of the image data encoded by the encoding section, and calculating an average amount of code using information on a past amount of code for each viewpoint and for each picture type; and an average-rate calculation section calculating an average bit rate using the average amount of code calculated by the amount-of-code calculation section for each viewpoint and for each picture type.

### BACKGROUND

The present disclosure relates to an image processing apparatus, and a method of processing an image and video.

In recent years, image processing apparatuses conforming to compression methods (for example, MPEG (Moving Picture Experts Group)) are becoming widespread both for information distribution at a broadcasting station, etc., and information receiving at ordinary households. In the compression methods, image information is processed as digital data, and the digital data is compressed by orthogonal transformation, such as discrete cosine transformation and motion compensation using redundancy specific to image information in order to transmit and store the image information with high efficiency.

Further, in recent years, a standard called AVC (Advanced Video Coding)(MPEG4 part10, ISO/IEC 14496-10|ITU-T (International Telecommunication Union—Telecommunication Standardization Sector) H.264)(In the following, referred to as AVC/H.264) is being defined. Between ITU-T and ISO/IEC, an organization called JVT (Joint Video Team) was formed so that video coding is jointly standardized, and the organization is developing the specification. It is noted that H.264 demands a larger amount of calculation for coding and decoding compared with related-art coding methods, such as MPEG2 and MPEG4, but achieves higher coding efficiency.

Compared with existing video coding methods, such as MPEG2 and MPEG4, AVC/H.264 achieves compression efficiency (coding efficiency) two times or more higher than that of the existing methods, but the amount of decoding processing dramatically increases as much. Also, the amount of decoding processing further increases with an increase in the amount of image data on the basis of improvement of image qualities. However, for example, there are cases where a permissible range of delay by decoding processing is small, and decoding processing is demanded to be fast and stable as in the case of decoding bit streams of encoded data that is transmitted in sequence, and in the case of reading and decoding encoded data recorded on a recording medium to reproduce the image.

Disclosures on video coding include, for example, Japanese Unexamined Patent Application Publication No. 2005-151344. Japanese Unexamined Patent Application Publication No. 2005-151344 has disclosed a technique for controlling an amount of code in order to follow an average rate while a quantized value in each picture is stabilized for each scene at the time of encoding a general two-dimensional (2D) video. By the disclosure of Japanese Unexamined Patent Application Publication No. 2005-151344, it is possible to obtain a high-quality encoded image when a two-dimensional video is encoded.

On the other hand, home television sets for displaying stereoscopic (3D) contents that give a user a stereoscopic vision with perception of depth and distance have started to be on the market in earnest. With this trend, demands for creating a lot of 3D contents have been increasing. There are various kinds of 3D-video methods. One of the methods among them is a frame-sequential method. In the frame-sequential method, right-eye images and left-eye images are alternately displayed at a high speed. The method enables the user to have stereoscopic vision by providing the user with the two images through shutter glasses.

### SUMMARY

An amount of code differs greatly for each picture type (for example, I-picture, P-picture, and B-picture), and thus amount-of-code control is generally performed for each picture type. In Japanese Unexamined Patent Application Publication No. 2005-151344, an amount of code is measured for each picture type, an average amount of code is calculated for each picture type, and the amount of code is controlled while quantized values are stabilized for each scene.

However, in a frame-sequential method, pictures of a same picture type sometimes have greatly different amounts of code if the pictures pertain to videos taken from different viewpoints. Thus, if video images of the frame-sequential method are encoded by a related-art amount-of-code control, such as the disclosure described in Japanese Unexamined Patent Application Publication No. 2005-151344, an average amount of code is calculated from pictures that are of a same picture type, but have greatly different amounts of code. Accordingly, there has been a problem in that the average amount of code changes abruptly, and the control oscillates.

Accordingly, the present disclosure has been made in view of the above-described problems. It is desirable to suitably calculate an amount of code at the time of encoding video images of a frame-sequential method so as to provide a new and improved image processing apparatus that is capable of suppressing an abrupt change in the average amount of code and oscillation in control to enable stable amount-of-code control, and to a method of processing an image and video.

According to an embodiment of the present disclosure, there is provided an image processing apparatus including: an encoding section encoding image data including images from a plurality of viewpoints; an amount-of-code calculation section determining a viewpoint and a picture type of the image data encoded by the encoding section, and calculating an average amount of code using information on a past amount of code for each viewpoint and for each picture type; and an average-rate calculation section calculating an average bit rate using the average amount of code calculated by the amount-of-code calculation section for each viewpoint and for each picture type.

The above-described image processing apparatus may further include a weighting-factor calculation section calculating, for each viewpoint and for each picture type, a weighting factor to be used for calculating an average amount of code for each viewpoint and for each picture type in the amount-of-code calculation section using the image data to be encoded.

The weighting-factor calculation section may vary the weighting factor depending on whether the image data to be encoded is data of a section including image data from a plurality of viewpoints.

The weighting-factor calculation section may detect a scene of the image data to be encoded, and may vary the weighting factor in accordance with a motion size.

The above-described image processing apparatus may further include a quantized-value calculation section calculating a quantized value used for encoding in the encoding section using the average bit rate calculated by the average-rate calculation section using the average amount of code calculated for each viewpoint and for each picture type.

The image data may include frame-sequential image data.

Also, according to another embodiment of the present disclosure, there is provided a method of processing an image, the method including: encoding image data including images from a plurality of viewpoints recorded alternately in frames; determining a viewpoint and a picture type of the image data encoded by the encoding, and calculating an average amount of code using information on a past amount of code for each viewpoint and for each picture type; and calculating an average bit rate using the average amount of code calculated by the calculating the average amount of code for each viewpoint and for each picture type.

As described above, by the present disclosure, it is possible to suitably calculate an amount of code at the time of encoding video images of a frame-sequential method so as to provide a new and improved image processing apparatus that is capable of suppressing an abrupt change in the average amount of code and oscillation in control to enable stable amount-of-code control, and to a method of processing an image and video.

### BRIEF DESCRIPTION OF THE DRAWINGS

FIG. 1 is an explanatory diagram illustrating an overall configuration of an image processing system according to an embodiment of the present disclosure;

FIG. 2 is an explanatory diagram illustrating a configuration of a coding apparatus according to an embodiment of the present disclosure;

FIG. 3 is an explanatory diagram illustrating a configuration of a Q-calculation circuit included in the coding apparatus according to an embodiment of the present disclosure;

FIG. 4 is a flowchart illustrating operation of the coding apparatus according to an embodiment of the present disclosure;

FIG. 5 is an explanatory diagram illustrating an example in which a change in an amount of code of each picture is arranged in time series;

FIG. 6 is an explanatory diagram illustrating a case of calculating an average amount of code by a related-art method;

FIG. 7 is an explanatory diagram illustrating a case of calculating an average amount of code by applying coding processing according to the present embodiment;

FIG. 8 is an explanatory diagram illustrating a variation of a configuration of a Q-calculation circuit included in the coding apparatus according to an embodiment of the present disclosure; and

FIG. 9 is an explanatory diagram illustrating an example of a hardware configuration of the coding apparatus according to an embodiment of the present disclosure.

### DETAILED DESCRIPTION OF EMBODIMENTS

In the following, a detailed description will be given of preferred embodiments of the present disclosure with reference to the accompanying drawings. In this regard, in this specification and the drawings, a same reference numeral is given to a component having a substantially same functional configuration, and a duplicated explanation will be omitted.

In this regard, the description will be given in the following order.

1. An embodiment of the present disclosure

1.1 Overall configuration of image processing system

1.2 Configuration of coding apparatus

1.3 Configuration of Q-calculation circuit

1.4 Operation of coding apparatus

1.5 Variation of Q-calculation circuit

1.6 Example of hardware configuration

2. Summary

### 1. An Embodiment of the Present Disclosure

### 1.1 Overall Configuration of Image Processing System

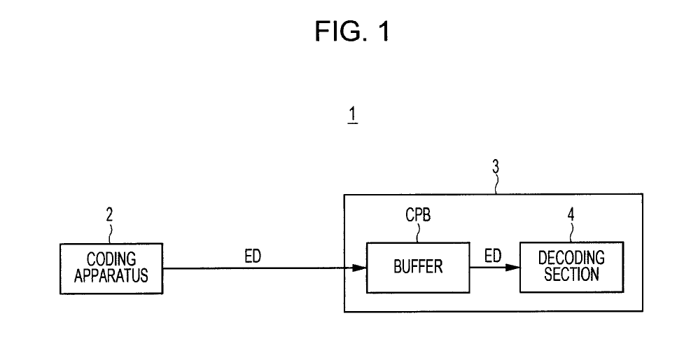

First, a description will be given of an overall configuration of an image processing system according to an embodiment of the present disclosure. FIG. 1 is an explanatory diagram illustrating an overall configuration of an image processing system 1 according to an embodiment of the present disclosure. In the following, a description will be given of an overall configuration of the image processing system 1 according to an embodiment of the present disclosure using FIG. 1.

As shown in FIG. 1, the image processing system 1 includes a coding apparatus 2 and a decoding apparatus 3. The coding apparatus 2 generates encoded data ED (a bit stream) that is compressed by orthogonal transformation, such as discrete cosine transformation, Karhunen-Loeve transformation, etc., and motion compensation, then modulates the encoded data ED, and transmits the data through a transmission medium, such as a satellite broadcasting wave, a cable-TV network, a telephone circuit network, a cellular-phone communication network, etc.

The decoding apparatus 3, for example, demodulates the encoded data ED received from the coding apparatus 2, then stores the data into a buffer CPB, and supplies the encoded data ED read from the buffer CPB to a decoding section 4. The decoding section 4 generates and uses the image data decoded by the inverse transformation to the orthogonal transformation at the time of the encoding and the motion compensation.

Here, the amount of data decreased from the amount of data stored in the buffer CPB by supplying one picture from the buffer CPB to the decoding section 4 depends on the amount of data of that picture, that is to say, a quantization parameter of that picture.

As described later, the coding apparatus 2 determines the above-described quantizer scale so as to prevent an overflow and underflow of the buffer CPB of the decoding apparatus 3.

In this regard, the transmission medium may be a recording medium, such as an optical disc, a magnetic disk, a semiconductor memory, etc.

The image processing system 1 has a characteristic in a method of calculating the quantizer scale in the coding apparatus 2.

In the above, a description has been given of the overall configuration of the image processing system 1 according to an embodiment of the present disclosure using FIG. 1. Next, a description will be given of a configuration of the coding apparatus 2 according to an embodiment of the present disclosure.

### 1.2 Configuration of Coding Apparatus

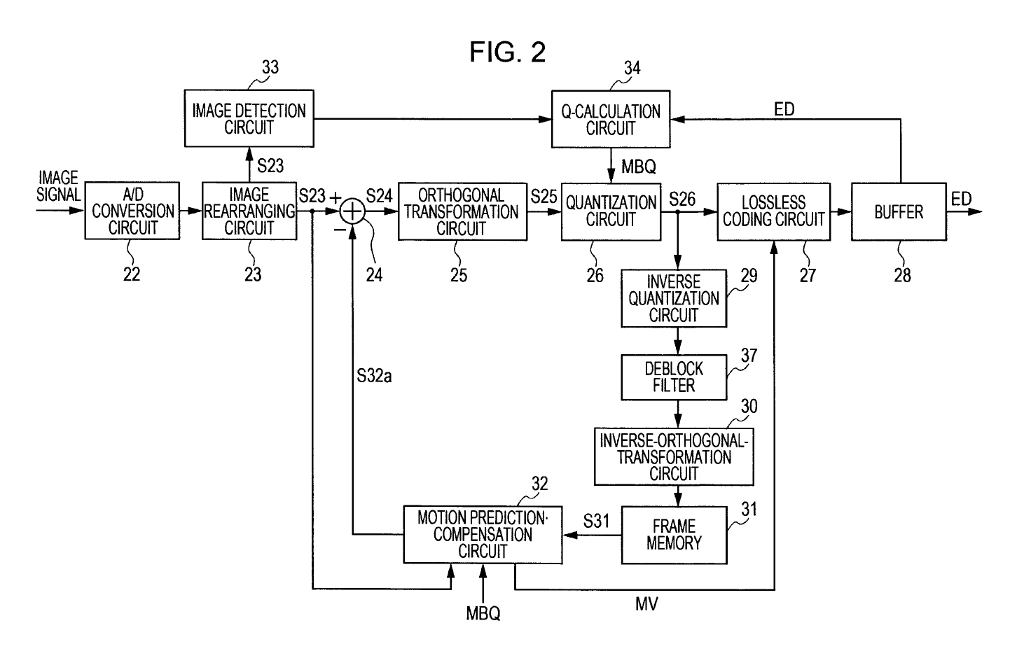

FIG. 2 is an explanatory diagram illustrating a configuration of the coding apparatus 2 according to an embodiment of the present disclosure. In the following, a description will be given of the configuration of the coding apparatus 2 according to an embodiment of the present disclosure using FIG. 2.

As shown in FIG. 2, the coding apparatus 2 according to an embodiment of the present disclosure includes an A/D conversion circuit 22, an image rearranging circuit 23, a calculation circuit 24, an orthogonal transformation circuit 25, a quantization circuit 26, a lossless coding circuit 27, a buffer 28, an inverse quantization circuit 29, an inverse-orthogonal-transformation circuit 30, a frame memory 31, a motion prediction compensation circuit 32, an image detection circuit 33, a Q-calculation circuit 34, and a deblock filter 37.

The A/D conversion circuit 22 converts an image signal including an analog luminance signal Y, color difference signals Pb and Pr, which is input into the coding apparatus 2, into a digital image signal. The A/D conversion circuit 22 outputs the digital image signal obtained by the conversion to the image rearranging circuit 23.

The image rearranging circuit 23 rearranges frame image signals in the digital image signal input from the A/D conversion circuit 22 in the order to be encoded in accordance with a GOP (Group Of Pictures) structure including the picture types I, P, and B thereof. The image rearranging circuit 23 outputs the rearranged image data S23 to the calculation circuit 24, the motion prediction compensation circuit 32, and the image detection circuit 33.

If the image data S23 is subjected to inter-coding, the calculation circuit 24 generates image data S24 indicating a difference between the image data S23 output from the image rearranging circuit 23 and prediction image data S32a output from the motion prediction compensation circuit 32, and outputs the data to the orthogonal transformation circuit 25. Also, if the image data S23 is subjected to intra-coding, the calculation circuit 24 outputs the image data S23 to the orthogonal transformation circuit 25 as the image data S24.

The orthogonal transformation circuit 25 performs orthogonal transformation, such as discrete cosine transformation, Karhunen-Loeve transformation, etc., on the image data S24 supplied from the calculation circuit 24 to generate image data (for example, a DCT coefficient signal) S25. The orthogonal transformation circuit 25 outputs the generated image data to the quantization circuit 26.

The quantization circuit 26 quantizes the image data S25 for each macroblock MB using a quantizer scale MBQ input from the Q-calculation circuit 34 described later to generate image data S26. The quantization circuit 26 outputs the generated image data S26 to the lossless coding circuit 27 and the inverse quantization circuit 29.

The lossless coding circuit 27 performs variable length coding or arithmetic coding on the image data S26 generated by having been quaintized by the quantization circuit 26 to generate encoded data ED. The lossless coding circuit 27 stores the generated encoded data ED into the buffer 28.

At this time, the lossless coding circuit 27 encodes a motion vector MV or the difference thereof supplied from the motion prediction compensation circuit 32 described later, and stores the data into header data of the encoded data ED.

The buffer 28 temporarily stores the encoded data ED generated by the lossless coding circuit 27. The encoded data ED stored in the buffer 28 is output to the Q-calculation circuit 34, then for example, is modulated, etc., and is transmitted to the decoding apparatus 3 shown in FIG. 1.

The inverse quantization circuit 29 generates inversely quantized data from the image data S26 quantized by the quantization circuit 26. The inverse quantization circuit 29 outputs data that has been inversely-quantized from the image data S26 to the deblock filter 37 described later. In this regard, the inverse quantization circuit 29 performs inverse quantization processing on the basis of, for example, the JVT standard.

The inverse-orthogonal-transformation circuit 30 performs inverse transformation to the orthogonal transformation in the above-described orthogonal transformation circuit 25 on the image data having been subjected to inverse quantization by the inverse quantization circuit 29 and from which block distortion has been eliminated by the deblock filter 37 to generate image data. The inverse-orthogonal-transformation circuit 30 stores the generated image data into the frame memory 31.

The frame memory 31 stores the image data produced in the inverse-orthogonal-transformation circuit 30 by having been subjected to the inverse transformation to the orthogonal transformation of the orthogonal transformation circuit 25. The image data stored in the frame memory 31 is supplied to the motion prediction compensation circuit 32 in sequence at predetermined timing as image data S31.

The motion prediction compensation circuit 32 performs motion prediction compensation processing on the basis of the image data S31 from the frame memory 31 and the image data S23 from the image rearranging circuit 23, and calculates a motion vector MV and prediction image data S32a. In this regard, the motion prediction compensation circuit 32 determines a macroblock type on the basis of a quantizer scale MBQ of the macroblock MB from the Q-calculation circuit 34, and performs motion prediction compensation processing on each block defined by the determined macroblock type.

The motion prediction compensation circuit 32 outputs the calculated motion vector MV to the lossless coding circuit 27, and outputs the prediction image data S32a to the calculation circuit 24.

The image detection circuit 33 detects what kind of image it is from the image data S23 (a picture of the original image). For example, the image detection circuit 33 calculates an activity indicating complexity of the image of the macroblock MB for each macroblock MB using the luminance-signal pixel values.

Specifically, the image detection circuit 33 calculates an average value of pixel data in a block used as a unit for each macroblock MB or for each predetermined block defined in the macroblock MB. And the image detection circuit 33 calculates activity values ACT of the macroblock MB on the basis of the sum of squares of the difference between each pixel data in the block used as the unit and the calculated average value, and outputs the activity values ACT of macroblock MB to the Q-calculation circuit 34. The activity value ACT increases in accordance with an increase in the complexity of the image of the macroblock MB.

Also, the image detection circuit 33 detects a violently moving scene, a still scene, a faded-in scene, a faded-out scene, and also detects a 2D-video section, a 3D section, and sends the detection results to the Q-calculation circuit 34.

The Q-calculation circuit 34 calculates a quantizer scale PicQ of each picture on the basis of the activity value ACT from the image detection circuit 33 and the encoded data ED of the buffer 28. Also, the Q-calculation circuit 34 calculates a quantizer scale MBQ of each macroblock MB included in each picture on the basis of the calculated quantizer scale PicQ, and outputs the quantizer scale MBQ to the quantization circuit 26 and the motion prediction compensation circuit 32.

In the following, a description will be given of a method of the Q-calculation circuit 34 calculating the quantizer scale PicQ on the basis of the encoded data ED.

The Q-calculation circuit 34 controls the quantizer scale PicQ of each picture, that is to say, the amount of data of each picture, in consideration of a state of the buffer CPB of the decoding apparatus 3 shown in FIG. 1 so that the amount of data of the encoded data ED stored in the buffer CPB comes close to a suitable value (an initial value InitialCpb).

Here, the number of pictures that are read from the buffer CPB in a unit time and supplied to the decoding section 4 is a constant value defined by a picture rate. Thus, the amount of data of each picture is controlled by the Q-calculation circuit 34 so that it is possible to control the amount of data (the amount of buffer storage) of the encoded data ED stored in the buffer CPB.

The deblock filter 37 performs processing for eliminating block distortion on the data produced by inversely quantizing the image data S26 by the inverse quantization circuit 29. The deblock filter 37 supplies the image data from which block distortion has been eliminated to the inverse-orthogonal-transformation circuit 30.

In the above, a description has been given of the coding apparatus 2 according to an embodiment of the present disclosure using FIG. 2. Next, a description will be given of a configuration of the Q-calculation circuit 34 included in the coding apparatus 2 according to an embodiment of the present disclosure.

### 1.3 Configuration of Q-Calculation Circuit

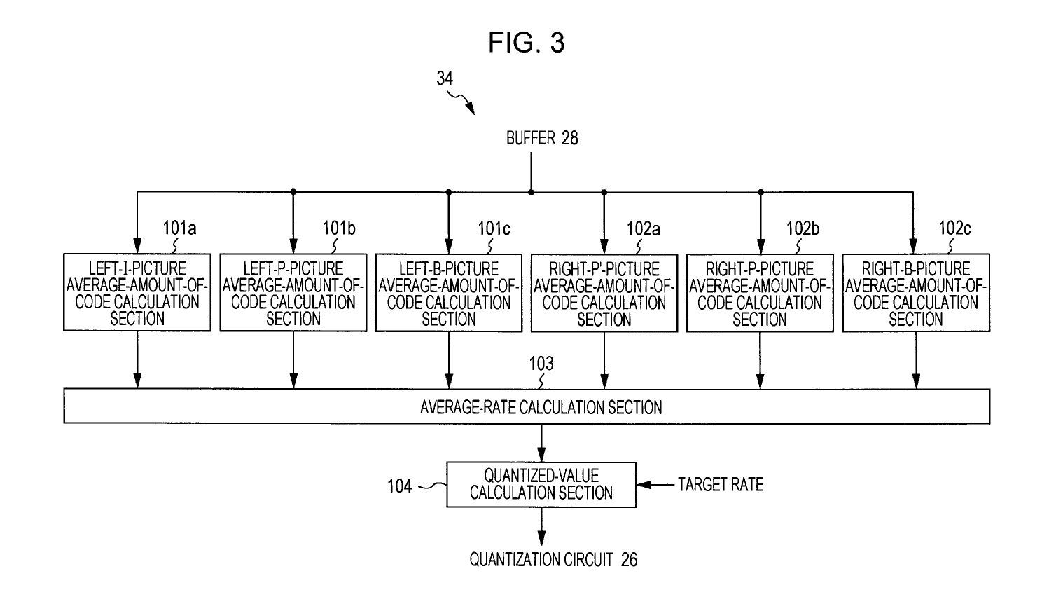

FIG. 3 is an explanatory diagram illustrating a configuration of the Q-calculation circuit 34 included in the coding apparatus 2 according to an embodiment of the present disclosure. In the following, a description will be given of a configuration of the Q-calculation circuit 34 included in the coding apparatus 2 according to an embodiment of the present disclosure using FIG. 3.

As shown in FIG. 3, the Q-calculation circuit 34 includes a left-I-picture average-amount-of-code calculation section 101a, a left-P-picture average-amount-of-code calculation section 101b, a left-B-picture average-amount-of-code calculation section 101c, a right-P′-picture average-amount-of-code calculation section 102a, a right-P-picture average-amount-of-code calculation section 102b, a right-B-picture average-amount-of-code calculation section 102c, an average-rate calculation section 103, and a quantized-value calculation section 104.

The left-I-picture average-amount-of-code calculation section 101a is supplied with the encoded data ED from the buffer 28, and calculates the average amount of code of I-pictures of the left-eye images that have been input in the past. The left-I-picture average-amount-of-code calculation section 101a outputs the calculated average amount of code of I-pictures of the left-eye images to the average-rate calculation section 103.

The left-P-picture average-amount-of-code calculation section 101b is supplied with the encoded data ED from the buffer 28, and calculates the average amount of code of P-pictures of the left-eye images that have been input in the past. In the same manner, the left-B-picture average-amount-of-code calculation section 101c is supplied with the encoded data ED from the buffer 28, and calculates the average amount of code of B-pictures of the left-eye images that have been input in the past. The left-P-picture average-amount-of-code calculation section 101b and the left-B-picture average-amount-of-code calculation section 101c output the calculated average amounts of code to the average-rate calculation section 103 in the same manner.

When the left-I-picture average-amount-of-code calculation section 101a, etc., calculate the average amount of code, the left-I-picture average-amount-of-code calculation section 101a, etc., use information on the encoded data ED of a few frames immediately before. The number of frames to be used for calculating the average amount of code may be any number.

The right-P′-picture average-amount-of-code calculation section 102a is supplied with the encoded data ED from the buffer 28, and calculates the average amount of code of the P′-pictures of the right-eye images that have been input in the past. In this regard, the P′-picture indicates a P-picture of the right-eye viewpoint at the same time as the I-picture of the left-eye viewpoint. The right-P′-picture average-amount-of-code calculation section 102a outputs the calculated average amount of code of the P′-pictures of the right-eye images to the average-rate calculation section 103.

The right-P-picture average-amount-of-code calculation section 102b is supplied with the encoded data ED from the buffer 28, and calculates the average amount of code of P-pictures of the right-eye images that have been input in the past. In the same manner, the right-B-picture average-amount-of-code calculation section 102c is supplied with the encoded data ED from the buffer 28, and calculates the average amount of code of B-pictures of the right-eye images that have been input in the past. The right-P-picture average-amount-of-code calculation section 102b and the right-B-picture average-amount-of-code calculation section 102c output the calculated average amounts of code to the average-rate calculation section 103 in the same manner.

When the right-P′-picture average-amount-of-code calculation section 102a, etc., calculate the average amount of code, the right-P′-picture average-amount-of-code calculation section 102a, etc., uses information on the encoded data ED of a few frames immediately before. The number of frames to be used for calculating the average amount of code may be any number.

The average-rate calculation section 103 obtains information on the average amount of code for each viewpoint and for each picture from the left-I-picture average-amount-of-code calculation section 101a, the left-P-picture average amount-of-code calculation section 101b, the left-B-picture average-amount-of-code calculation section 101c, the right-P′-picture average amount-of-code calculation section 102a, the right-P-picture average-amount-of-code calculation section 102b, and the right-B-picture average amount-of-code calculation section 102c to calculate the average bit rate.

When the average-rate calculation section 103 calculates the average bit rate by obtaining the information on the average amount of code of each picture, the average-rate calculation section 103 sends information on the calculated average bit rate to the quantized-value calculation section 104.

The quantized-value calculation section 104 calculates a quantized value using the average bit rate calculated by the average-rate calculation section 103 and the information on the target bit rate sent from the outside of the quantized-value calculation section 104. Specifically, the quantized-value calculation section 104 calculates the quantized value such that the average bit rate calculated by the average-rate calculation section 103 comes close to the target bit rate.

The calculation of the quantized value in the quantized-value calculation section 104 may use, for example, a method described in Japanese Unexamined Patent Application Publication No. 2005-151344. Also, for the information of the target bit rate to be supplied to the quantized-value calculation section 104, for example, a method described in Japanese Unexamined Patent Application Publication No. 2005-151344 may be used.

The quantized value calculated by the quantized-value calculation section 104 is sent to the quantization circuit 26 in FIG. 2. The quantization circuit 26 performs quantization using the quantized values calculated by the quantized-value calculation section 104. By configuring the Q-calculation circuit 34 in this manner, it is possible to separately measure an amount of code of a frame-sequential video for each picture type and for each viewpoint. The frame-sequential video is measured for each picture type and for each viewpoint so that it is possible to suppress abrupt fluctuations of the amount of code for each picture type and for each viewpoint, and thus to stabilize the amount-of-code control.

In the above, a description has been given of a configuration of the Q-calculation circuit 34 included in the coding apparatus 2 according to an embodiment of the present disclosure using FIG. 3. Next, a description will be given of the operation of the coding apparatus 2 according to an embodiment of the present disclosure.

### 1.4 Operation of Coding Apparatus

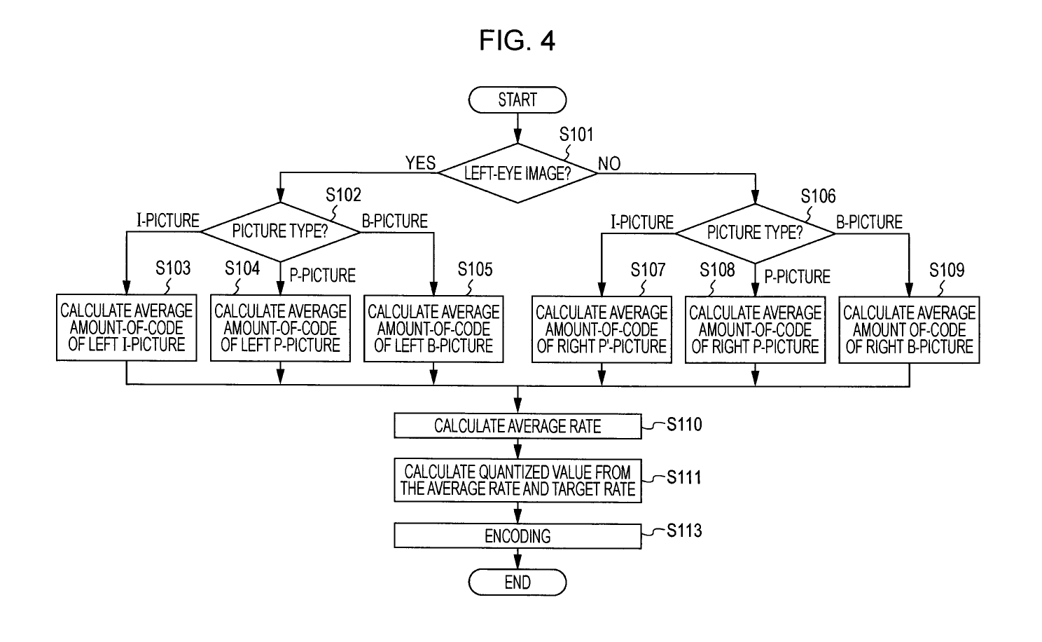

FIG. 4 is a flowchart illustrating operation of the coding apparatus 2 according to an embodiment of the present disclosure. FIG. 4 mainly illustrates the operation of the Q-calculation circuit 34. In the following, a description will be given of the operation of the coding apparatus 2 according to an embodiment of the present disclosure using FIG. 4.

When the buffer 28 supplies the encoded data ED to the Q-calculation circuit 34, the Q-calculation circuit 34 first determines whether the encoded data ED supplied from the buffer 28 is data produced by encoding a left-eye image or not (step S101). The determination of whether the data is encoded from a left-eye image or not may be made, for example, depending on whether that picture is disposed at how many intervals apart from a reference I-picture. If the reference I-picture is a left-eye image, it is possible to determine that a picture disposed at even-numbered intervals apart from the I-picture is a left-eye image, and a picture disposed at odd-numbered intervals apart from the I-picture is a right-eye image.

As a result of the determination in step S101, if the encoded data ED sent from the buffer 28 is encoded data of a left-eye image, a determination is made of what picture type the encoded data ED is next (step S102).

As a result of the determination in step S102, if the picture type is an I-picture, the left-I-picture average-amount-of-code calculation section 101a calculates the average amount of code of the I-pictures of the left-eye image (step S103). Also, as a result of the determination in step S102, if the picture type is a P-picture, the left-P-picture average-amount-of-code calculation section 101b calculates the average amount of code of the P-pictures of the left-eye image (step S104). And as a result of the determination in step S102, if the picture type is a B-picture, the left-B-picture average-amount-of-code calculation section 101c calculates the average amount of code of the B-pictures of the left-eye image (step S105).

On the other hand, as a result of the determination in step S101, if the encoded data ED sent from the buffer 28 is encoded data of a right-eye image, a determination is made of what picture type the encoded data ED is next (step S106).

As a result of the determination in step S106, if the picture type is a P′-picture, the right-P′-picture average-amount-of-code calculation section 102a calculates the average amount of code of the P′-pictures of the right-eye image (step S107). Also, a result of the determination in step S106, if the picture type is a P-picture, the right-P-picture average-amount-of-code calculation section 102b calculates the average amount of code of the P-pictures of the right-eye image (step S108). And as a result of the determination in step S106, if the picture type is a B-picture, the right-B-picture average-amount-of-code calculation section 102c calculates the average amount of code of the B-pictures of the right-eye image (step S109).

When the average amount of code for each viewpoint and for each picture is calculated, next, the average-rate calculation section 103 calculates the average bit rate using the calculated average amount of code (step S110). By calculating the average amount of code for each viewpoint and for each picture, and then calculating the average bit rate using those average amounts of code, it is possible to stabilize the output of the average-rate calculation section 103.

In step S110, when the average-rate calculation section 103 calculates the average bit rate using the average amount of code for each viewpoint and for each picture, next, the quantized-value calculation section 104 calculates a quantized value using the average bit rate calculated in step S110 and the target bit rate sent from the outside of the quantized-value calculation section 104 (step S111).

In step S111, when the quantized-value calculation section 104 calculates the quantized value, the coding apparatus 2 executes coding processing using the quantized value (step S112). Specifically, the quantization circuit 26 performs quantization processing using the quantized value calculated by the quantized-value calculation section 104.

Here, a description will be given of the difference in the average amount of code in the case where related-art technique is applied without change and the case where the coding processing according to the present embodiment is applied by giving an example.

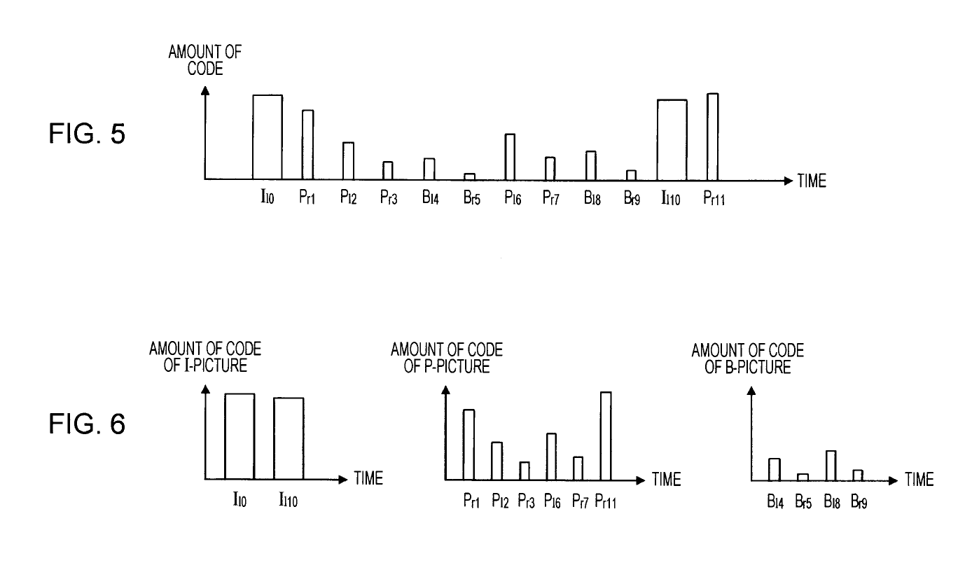

FIG. 5 is an explanatory diagram illustrating an example in which a change in an amount of code of each picture is arranged in time series. Reference numerals I₁₀ and I₁₁₀ represent the amounts of code of I-pictures of a left-eye image, and reference numerals Pᵣ₁ and Pᵣ₁₁ represent the amounts of code of the P′-pictures of a right-eye image. In the same manner, reference numerals P₁₂ and P₁₆ represent the amounts of code of the P-pictures of the left-eye image, and reference numerals Pᵣ₃ and Pᵣ₇ represent the amounts of code of the P-pictures of the left-eye image. And reference numerals B₁₄ and B₁₈ represent the amounts of code of the B-pictures of the left-eye image, and reference numerals Bᵣ₅ and Bᵣ₉ represent the amounts of code of the B-pictures of the right-eye image.

In this manner, in a 3D video, images having different viewpoints are alternately encoded, and thus even if frames are of same picture type, an amount of code sometimes differs greatly for each frame.

FIG. 6 is an explanatory diagram illustrating a case of calculating an average amount of code by a related-art method. Up to now, the average amount of code has been calculated simply for each picture type. Accordingly, if an average amount of code is calculated simply for each picture type, as the P-picture and the B-picture shown in FIG. 6, when an amount of code fluctuates sharply, the average amount of code fluctuates greatly, and thus there has been a problem in that the control diverges.

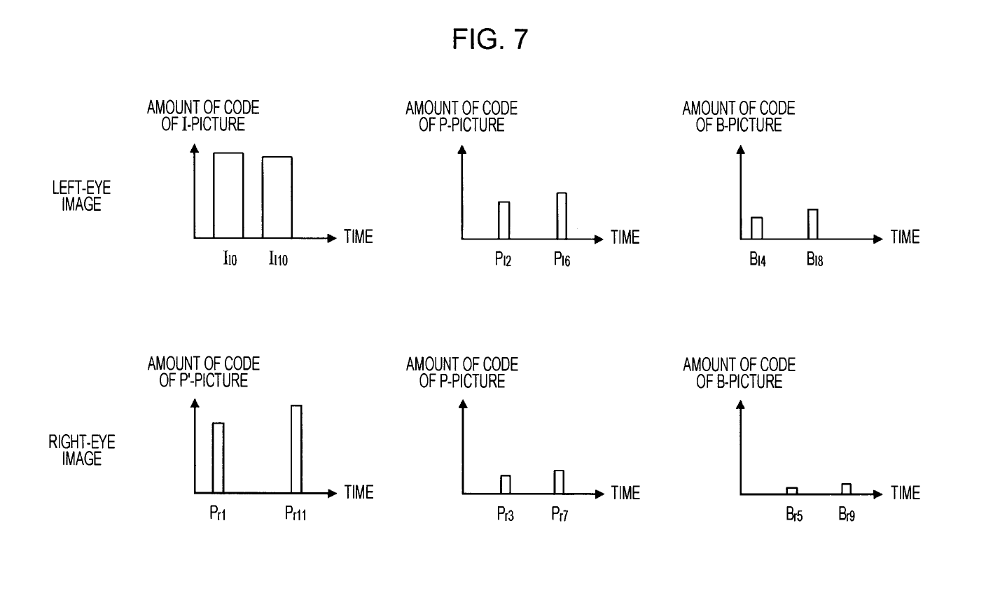

FIG. 7 is an explanatory diagram illustrating a case of calculating an average amount of code by applying coding processing according to the present embodiment. In this manner, if the average amount of code is calculated for each viewpoint and for each picture type, fluctuations of the amount of code are suppressed, and the average amount of code does not fluctuate greatly. Accordingly, it is possible to suppress divergence of the control of the amount-of-code with the use of the coding processing according to the present embodiment.

In the above, a description has been given of the operation of the coding apparatus 2 according to an embodiment of the present disclosure using FIG. 4. Next, a description will be given of an example of variation of a configuration of the Q-calculation circuit 34 included in the coding apparatus 2 according to an embodiment of the present disclosure.

### 1.5 Variation of Q-Calculation Circuit

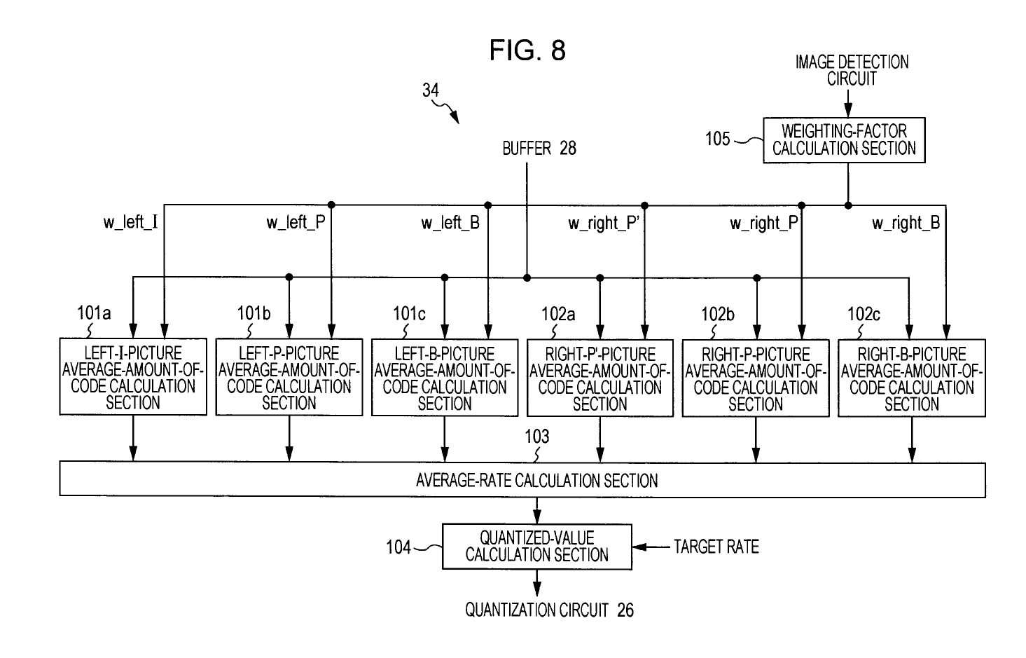

FIG. 8 is an explanatory diagram illustrating a variation of a configuration of the Q-calculation circuit 34 included in the coding apparatus 2 according to an embodiment of the present disclosure. In the following, a description will be given of an example of a variation of a configuration of the Q-calculation circuit 34 included in the coding apparatus 2 according to an embodiment of the present disclosure using FIG. 8.

The Q-calculation circuit 34 shown in FIG. 8 is the configuration in which a weighting-factor calculation section 105 is added to the Q-calculation circuit 34 shown in FIG. 3. The weighting-factor calculation section 105 obtains information on an image to be encoded from the image detection circuit 33, and calculates a weighting factor to be used for the calculation of the average amount of code. The weighting factor calculated by the weighting-factor calculation section 105 is a weighting factor w to be used for calculating the average amount of code by the following expression.

average_bit(n)=w*average_bit(n−1)+(1−w)*current_bit

where average_bit (n) means the average amount of code of the n-th frame. And current_bit represents the amount of code of the current frame.

In this regard, the weighting-factor calculation section 105 may calculate a same weighting factor for each viewpoint and for each picture type. Alternatively, the weighting-factor calculation section 105 may calculate a different weighting factor for each viewpoint. Also, the weighting-factor calculation section 105 may calculate a different weighting factor for each viewpoint and for each picture type. As an example, FIG. 8 shows a state in which the weighting-factor calculation section 105 calculates a different weighting factor for each viewpoint and for each picture type.

That is to say, the weighting-factor calculation section 105 calculates a weighting factor w_left_I for the left-I-picture average-amount-of-code calculation section 101a, calculates a weighting factor w_left_P for the left-P-picture average-amount-of-code calculation section 101b, calculates a weighting factor w_left_B for the left-B-picture average-amount-of-code calculation section 101c, and sends the calculated weighting factor to each section. In the same manner, the weighting-factor calculation section 105 calculates a weighting factor w_right_P′ for the right-P′-picture average-amount-of-code calculation section 102a, calculates a weighting factor w_right_P for the right-P-picture average-amount-of-code calculation section 102b, calculates a weighting factor w_right_B for the right-B-picture average-amount-of-code calculation section 102c, and sends the calculated weighting factor to each section.

In this manner, the weighting-factor calculation section 105 individually calculates a different weighting factor for each viewpoint and for each picture type so that it becomes possible to calculate the average amount of code with suitable weighting for each viewpoint and for each picture type in accordance with the contents of a three-dimensional video to be encoded.

The image detection circuit 33 sends scene information indicating what kind of scene of a video is to be encoded to the weighting-factor calculation section 105. For an example of a scene, a violently moving scene, a still scene, a faded-in scene, a faded-out scene, etc., are included. Also, the image detection circuit 33 detects information on whether a video to be encoded is a video of a 2D-video section or a video of a 3D-video section, and sends the information to the weighting-factor calculation section 105.

The weighting-factor calculation section 105 decreases the weighting factor w, for example, for a violently moving scene, a faded-in scene, and a faded-out scene in order to increase following ability of rate. On the other hand, the weighting-factor calculation section 105 increases the weighting factor for a scene with little motion in order to stabilize the quantized value. Also, in the case of a video in which a 2D-video section and a 3D-video section are mixed, the weighting-factor calculation section 105 may change the weighting factor w for a left-eye image and a right-eye image depending on whether the 2D-video section or the 3D-video section.

In this manner, information on the image to be encoded is obtained from the image detection circuit 33, and the weighting-factor calculation section 105 calculates the weighting factor to be used at the time of calculating the average amount of code so that it becomes possible to produce the average amount of code suitable for the contents of a video.

### 1.6 Example of Hardware Configuration

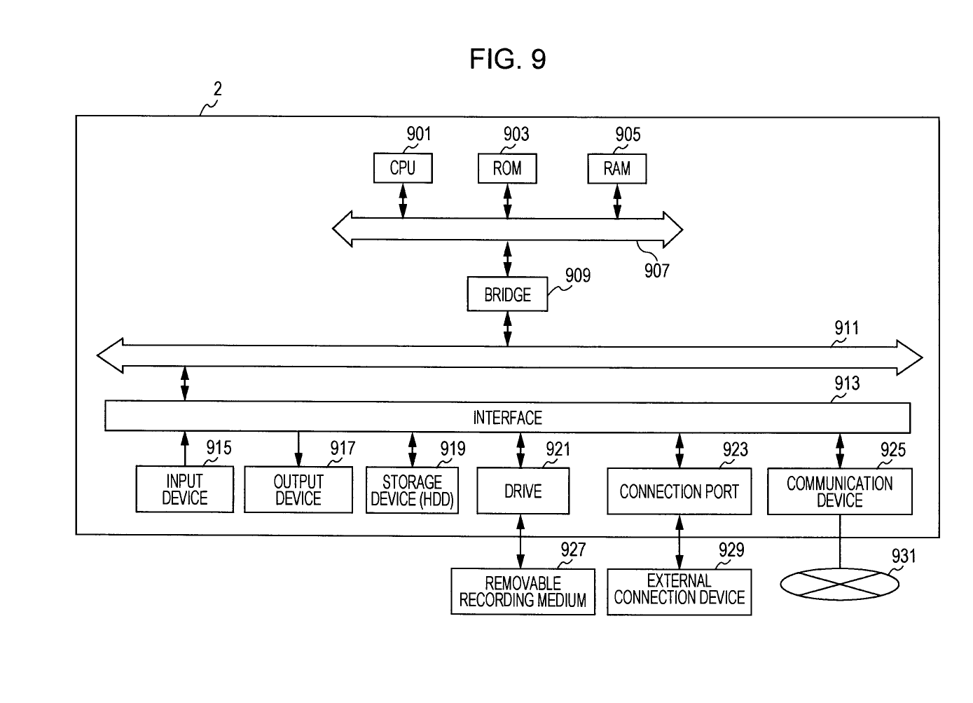

Next, a description will be given of an example of a hardware configuration of the coding apparatus 2 according to an embodiment of the present disclosure described above. FIG. 9 is an explanatory diagram illustrating an example of the hardware configuration of the coding apparatus 2 according to an embodiment of the present disclosure.

As shown in FIG. 9, the coding apparatus 2 according to an embodiment of the present disclosure mainly includes, a CPU 901, a ROM 903, a RAM 905, a host bus 907, a bridge 909, an external bus 911, an interface 913, an input device 915, an output device 917, a storage device 919, a drive 921, a connection port 923, and a communication device 925.

The CPU 901 functions as an operation processing unit and a control unit, and controls overall or part of operation of an image processing apparatus 100 in accordance with various programs recorded in the ROM 903, the RAM 905, the storage device 919, or the removable recording medium 927. The ROM 903 stores programs, operation parameters, etc., used by the CPU 901. The RAM 905 temporarily stores programs to be used by execution of the CPU 901, and parameters to be changed in the execution, etc. These are mutually connected by a host bus 907 including an internal bus, such as a CPU bus, etc.

The host bus 907 is connected to an external bus 911, such as a PCI (Peripheral Component Interconnect/Interface) bus, etc., through a bridge 909.

The input device 915 is an operation means that is operated by a user, for example, a mouse, a keyboard, a touch panel, a button, a switch and a lever, etc. Also, the input device 915 may be, for example, a remote control means (a so-called remote controller) using infrared rays and the other radio waves, or may be an external connection device 929, such as a cellular phone supporting the operation of the image processing apparatus 100, a PDA, etc. Further, the input device 915 includes, for example, an input control circuit, etc., which creates an input signal on the basis of the information input by the user using the above-described operation means and outputs the signal to the CPU 901, etc. It is possible for the user of the image processing apparatus 100 to input various kinds of data to the image processing apparatus 100 and instructs processing operations by operating the input device 915.

The output device 917 includes a display device such as, for example, a CRT display device, a liquid-crystal display device, a plasma display device, an EL display device, and a lamp, etc., an audio output device, such as a speaker, a headphone, etc., and a device capable of informing a user of obtained information visually or aurally, such as a printer, a cellular phone, a facsimile, etc. The output device 917 outputs, for example, a result obtained by various kinds of processing performed by the image processing apparatus 100. Specifically, the display device displays a result obtained by the various kinds of processing performed by the image processing apparatus 100 by text or an image. On the other hand, the audio output device converts an audio signal including reproduced voice data, audio data, etc., into an analog signal, and outputs the signal.

The storage device 919 includes, for example, a magnetic storage device, such as an HDD (Hard Disk Drive), etc., a semiconductor storage device, an optical storage device, or a magneto-optical storage device, etc. The storage device 919 stores programs to be executed by the CPU 901, various kinds of data, and audio signal data and image signal data that are obtained from the outside, etc.

The drive 921 is a reader/writer for a recording medium, and is built in, or externally attached to the image processing apparatus 100. The drive 921 reads out information recorded in a removable recording medium 927, such as an attached magnetic disk, an optical disc, a magneto-optical disc, or a semiconductor memory, etc., and outputs the information to the RAM 905. Also, the drive 921 is capable of writing records into a removable recording medium 927, such as an attached magnetic disk, an optical disc, a magneto-optical disc, or a semiconductor memory, etc. The removable recording medium 927 is, for example, a DVD medium, a Blu-ray medium, a CompactFlash (CF) (registered trademark), a memory stick, or an SD memory card (Secure Digital memory card), etc. Also, the removable recording medium 927 may be, for example, an IC card (Integrated Circuit card) on which a non-contact IC chip is mounted, or an electronic device, etc.

The connection port 923 is a port for directly connecting a device to the image processing apparatus 100, for example, a USB (Universal Serial Bus) port, an IEEE1394 port, such as i.Link, etc., a SCSI (Small Computer System Interface) port, an RS-232C port, an optical audio terminal, an HDMI (High-Definition Multimedia Interface) port, etc. By connecting an external connection device 929 to the connection port 923, the image processing apparatus 100 directly obtains audio signal data and image signal data from the external connection device 929, and provides the external connection device 929 with audio signal data and image signal data.

The communication device 925 is a communication interface including a communication device, etc., for connecting to a communication network 931, for example. The communication device 925 is, for example, a communication card for a wired or wireless LAN (Local Area Network), Bluetooth, or WUSB (Wireless USB), an optical communication router, an ADSL (Asymmetric Digital Subscriber Line) router, or various kinds of communication modems, etc. The communication device 925 is capable of transmitting/receiving signals between, for example, the Internet and the other communication devices in accordance with a predetermined protocol, for example, TCP/IP, etc. Also, the communication network 931 connected to the communication device 925 may include a network connected in a wired or wireless communication, etc., and may be, for example, the Internet, a home LAN, infrared data communication, radio wave communication or satellite communication, etc.

### 2. Summary

As described above, by an embodiment of the present disclosure, at the time of calculating a quantized value to be used for encoding video data, the coding apparatus 2 calculates the average amount of code for each viewpoint and for each picture type, and then calculates the average bit rate using the information of the average amount of code calculated for each viewpoint and for each picture type. And the coding apparatus 2 calculates the quantized value using the average bit rate calculated in this manner.

By calculating the average amount of code for each viewpoint and for each picture type in this manner, it is possible to suppress abrupt fluctuations in the average amount of code for each picture type and for each viewpoint. Accordingly, it is possible for the coding apparatus 2 according to an embodiment of the present disclosure to stabilize the amount-of-code control at the time of performing encoding processing on image data.

Also, a weighting factor to be used for calculating the average amount of code may be calculated in accordance with the contents of image data to be encoded. In this manner, by calculating a weighting factor to be used for calculating the average amount of code in accordance with the contents of the image data to be encoded, it becomes possible to precisely calculate the average amount of code for each viewpoint and for each picture type.

In the present specification, programming steps recorded in a recording medium includes, of course, the processing performed in time series in accordance with the described sequence, but also includes the processing that is not necessarily performed in time series, namely, the processing to be performed in parallel or individually.

Although the detailed descriptions have been given of the preferred embodiments of the present disclosure with reference to the accompanying drawings, the present disclosure is not limited to these embodiments. It is obvious to those skilled in the art of the present disclosure that various variations or modifications are possible within the scope of the appended claims. It is to be understood that the variations or modifications naturally fall within the spirit and scope of the present disclosure.

The present disclosure contains subject matter related to that disclosed in Japanese Priority Patent Application JP 2010-147633 filed in the Japan Patent Office on Jun. 29, 2010, the entire contents of which are hereby incorporated by reference.

What is claimed is:

1. An image processing apparatus comprising:
an encoding section encoding image data including images from a plurality of viewpoints;
an amount-of-code calculation section determining a viewpoint and a picture type of the image data encoded by the encoding section, and calculating an average amount of code using information on a past amount of code for each viewpoint and for each picture type; and
an average-rate calculation section calculating an average bit rate using the average amount of code calculated by the amount-of-code calculation section for each viewpoint and for each picture type.

2. The image processing apparatus according to claim 1, further comprising a weighting-factor calculation section calculating, for each viewpoint and for each picture type, a weighting factor to be used for calculating an average amount of code for each viewpoint and for each picture type in the amount-of-code calculation section using the image data to be encoded.

3. The image processing apparatus according to claim 2,
wherein the weighting-factor calculation section varies the weighting factor depending on whether the image data to be encoded is data of a section including image data from a plurality of viewpoints.

4. The image processing apparatus according to claim 2,
wherein the weighting-factor calculation section detects a scene of the image data to be encoded, and varies the weighting factor in accordance with a motion size.

5. The image processing apparatus according to claim 1, further comprising a quantized-value calculation section calculating a quantized value used for encoding in the encoding section using the average bit rate calculated by the average-rate calculation section using the average amount of code calculated for each viewpoint and for each picture type.

6. The image processing apparatus according to claim 1,
wherein the image data includes frame-sequential image data.

7. A method of processing an image, the method comprising:
encoding image data including images from a plurality of viewpoints recorded alternately in frames;
determining a viewpoint and a picture type of the image data encoded by the encoding, and calculating an average amount of code using information on a past amount of code for each viewpoint and for each picture type; and
calculating an average bit rate using the average amount of code calculated by the calculating the average amount of code for each viewpoint and for each picture type.
